(19) United States
(12) Patent Application Publication
(10) Pub. No.: US 2017/0215014 A1
(43) Pub. Date: Jul. 27, 2017

(54) HEARING DEVICE RECEIVER WITH ANGULAR MOMENTUM CANCELLATION

(71) Applicant: Sonion Nederland B.V., Hoofddorp (NL)

(72) Inventor: Rasmus Voss, Den Haag (NL)

(21) Appl. No.: 15/402,474

(22) Filed: Jan. 10, 2017

(30) Foreign Application Priority Data
Jan. 27, 2016 (EP) 16152930.0

(51) Int. Cl. H04R 25/00; H04R 19/04

(52) U.S. Cl. CPC H04R 25/604; H04R 19/04; H04R 2201/003; H04R 2225/021; H04R 2225/023; H04R 2225/025

(57) ABSTRACT

A receiver assembly including a moving armature having a first portion and a second portion, and a first diaphragm being operatively connected to the first portion of the moving armature. The first portion of the moving armature is operatively connected to the first diaphragm in a manner so that an angular momentum induced by movements of the first portion of the moving armature is essentially counteracted by an angular momentum induced by movements of the first diaphragm.

### CROSS-REFERENCE TO RELATED APPLICATION

This application claims the benefit of European Patent Application Serial No. 16152930.0, filed Jan. 27, 2016, which is incorporated herein by reference in its entirety.

### FIELD OF THE INVENTION

The present invention relates to a hearing device receiver, such as a hearing aid receiver. In particular, the present invention relates to a hearing device receiver implementation which facilitates that the total angular momentum around a centre point of the receiver is essentially zero.

### BACKGROUND OF THE INVENTION

Various arrangements to avoid, or at least reduce, the influence of angular momentums or torques in hearing device receivers have been suggested over the year. One often seen approach involves the use of two moving armature type motors in a dual receiver configuration. The moving armature type motors are arranged to move in opposite directions in response to a drive signal being provided to the dual receiver. These oppositely arranged movements may reduce the total angular momentum of the dual receiver significantly. An example of a dual receiver implementation may be found in US 2012/0255805 A1.

It is however disadvantageous that dual receiver implementations often become complex and costly. Also, a perfect match between the applied motors are required in order to completely cancel angular momentums.

It may be seen as an object of embodiments of the present invention to provide a hearing device receiver with low technical complexity.

It may be seen as a further object of embodiments of the present invention to provide a hearing device receiver where the total angular momentum around a centre point of the receiver is essentially zero.

### SUMMARY OF INVENTION

The above-mentioned objects are complied with by providing, in a first aspect, a receiver assembly comprising

1) a moving armature having a first portion, and

2) a first diaphragm being operatively connected to the first portion of the moving armature,

wherein the first portion of the moving armature is operatively connected to the first diaphragm in a manner so that an angular momentum induced by movements of the first portion of the moving armature is essentially counteracted by an angular momentum induced by movements of at least part of the first diaphragm.

The first portion of the moving armature and a part of the first diaphragm may induce a combined angular momentum in one direction. This combined angular momentum is however essentially counteracted by an oppositely directed angular momentum induced by another part of the first diaphragm.

Thus, the first aspect of the present invention aims at arranging a moving armature and a first diaphragm of a receiver assembly in a manner so that the total angular momentum in response to movements thereof is essentially zero, i.e. essentially counteracted or outbalanced, around a centre point.

Generally, the moving armature may be considered a pivotally mounted armature which is adapted to drive or move the first diaphragm in order to generate an audio signal in response to an incoming drive signal. The moving armature may be adapted to pivot or twist around the centre point separating the first portion and a second portion of the moving armature. It is around this centre point the total angular momentum should be essentially zero.

The receiver assembly of the present invention may be a so-called miniature receiver assembly which, due to its limited size, may be applied in hearing devices, such as hearing aids.

The receiver assembly of the first aspect of the present invention may further comprise a first magnetic air gap and a first drive coil being adapted to interact with the first portion of the moving armature. In the present context the term interact should be taken to mean that at least part of the first portion of the moving armature is positioned in the first magnetic air gap, and that the first drive coil may induce a magnetic flux in at least part of the moving armature in response to a drive signal being provided to said first drive coil.

The receiver assembly may further comprise a second diaphragm being operatively connected to the second portion of the moving armature, wherein the second portion of the moving armature is operatively connected to the second diaphragm in a manner so that an angular momentum induced by movements of the second portion of the moving armature is essentially counteracted by an oppositely directed angular momentum induced by movements of at least part of the second diaphragm.

The second portion of the moving armature and a part of the second diaphragm may induce a combined angular momentum in one direction. This combined angular momentum is however essentially counteracted by an oppositely directed angular momentum induced by another part of the second diaphragm. Thus, the receiver assembly of the present invention may comprise two diaphragms being operatively connected to the same moving armature. The total angular momentum of the receiver assembly around the centre point is essentially zero.

A second magnetic air gap and a second drive coil may be provided to interact with the second portion of the moving armature. Again, the term interact should be taken to mean that at least part of the second portion of the moving armature is positioned in the second magnetic air gap, and that the second drive coil may induce a magnetic flux in at least part of the moving armature in response to a drive signal being provided to said second drive coil.

The first and second magnetic air gaps may be defined by respective pairs of permanent magnets. The respective pairs of permanent magnets may be arranged at or near the opposite ends of the moving armature, i.e. the opposite ends of the moving armature may be positioned within the respective first and second magnetic air gaps. The respective pairs of permanent magnets may be magnetised in essentially the same direction.

As previously stated the moving armature may be adapted to pivot or twist around a centre point separating the first and second portions of the armature. In order to pivot or twist a drive signal needs to be provided to at least one of the first or second drive coils. The first drive coil may be adapted to interact with at least part of the first portion of the armature. This part of the moving armature may be positioned between the centre point and the first magnetic air gap. Similarly, the second drive coil may be adapted to interact with at least part of the second portion of the armature. This part of the moving armature may be between the centre point and the second magnetic air gap.

As previously addressed the moving armature may be operatively connected to both the first and second diaphragm. The first portion of the moving armature may be operatively connected to the first diaphragm at a position between the first drive coil and the centre point. Similarly, the second portion of the moving armature may be operatively connected to the second diaphragm at a position between the second drive coil and the centre point. The first and second diaphragms may be operatively connected to the respective first and second portions of the moving armature via substantially rigid connections, such as substantially rigid drivepins.

The above-mentioned connections between the moving armature and the respective first and second diaphragms are advantageous in that when the first portion of the moving armature moves in one direction a main part of the first diaphragm moves in the same direction. It should be noted however, that the movements of the first portion of the moving armature and at least part of the first diaphragm occur on opposite sides of the centre point of the moving armature whereby the total angular momentum become zero around the centre point if the masses of the moving armature, the first diaphragm and the drivepin (and the position thereof) are chosen correctly. Similarly, it is advantageous that when the second portion of the moving armature moves in one direction a main part of the second diaphragm moves in the same direction. Again it should be noted that the movements of the second portion of the moving armature and at least part of the second diaphragm occur on opposite sides of the centre point of the moving armature whereby the total angular momentum becomes zero around the centre point if the masses of the moving armature, the second diaphragm and the drivepin (and the position thereof) are chosen correctly.

Each of the first and second diaphragms may be hinged along at least one side. The opposite sides of the respective first and second diaphragms may be allowed to move freely.

The receiver assembly of the present invention may further comprise one or more microphone units, said one or more microphone units comprising one or more MEMS microphones and/or one or more electret microphones.

In a second aspect the present invention relates to a receiver assembly comprising

1) a moving armature having a first portion and a second portion,

2) a first diaphragm being operatively connected to the first portion of the moving armature, and

3) a second diaphragm being operatively connected to the second portion of the moving armature,

wherein angular momentums induced by combined movements of the first portion of the moving armature and the first diaphragm is essentially counteracted by angular momentums induced by combined movements of the second portion of the moving armature and the second diaphragm.

Thus, in the second aspect the receiver assembly of the present invention comprise two diaphragms being operative connected to the same moving armature. The moving armature is operatively connected to the first and second diaphragms in a manner so that the total angular momentum around a centre point of the receiver assembly become essentially zero, i.e. essentially counteracted or outbalanced.

Again, the moving armature may be considered a pivotally mounted armature which is adapted to drive or move the first and second diaphragms in order to generate an audio signal in response to an incoming drive signal. The moving armature may be adapted to pivot or twist around the centre point separating the first and second portions of the armature. It is around this centre point the total angular momentum should be essentially zero.

The receiver assembly of the second aspect of the present invention may further comprise a first magnetic air gap and a first drive coil, and a second magnetic air gap and a second drive coil being adapted to interact with the respective first and second portions of the moving armature. In the present context the term interact should be taken to mean that at least part of the first and second portions of the moving armature is positioned in the first and second magnetic air gap, respectively, and that the first and second drive coils may induce a magnetic flux in at least part of the moving armature in response to a drive signal being provided to said drive coils.

The first and second magnetic air gaps may be defined by respective pairs of permanent magnets. The respective pairs of permanent magnets may be arranged at or near opposite ends of the moving armature, i.e. the opposite ends of the moving armature are positioned within the respective first and second magnetic air gaps. The respective pairs of permanent magnets may be magnetised in essentially the same direction.

The moving armature may be adapted to pivot or twist around the centre point separating the first and second portions of the moving armature. In order to pivot or twist a drive signal needs to be provided to at least one of the first or second drive coils. The first drive coil may be adapted to interact with at least part of the first portion of the moving armature. This part of the moving armature may be positioned between the centre point and the first magnetic air gap. Similarly, the second drive coil may be adapted to interact with at least part of the second portion of the moving armature. This part of the moving armature may be between the centre point and the second magnetic air gap.

In the second aspect of the present invention the moving armature is operatively connected to both the first and second diaphragm. The first portion of the moving armature may be operatively connected to the first diaphragm at a position between the first drive coil and the centre point. Similarly, the second portion of the moving armature may be operatively connected to the second diaphragm at a position between the second drive coil and the centre point. The first and second diaphragms may be operatively connected to the respective first and second portions of the moving armature via substantially rigid connections, such as substantially rigid drivepins.

The above-mentioned connections between the moving armature and the respective first and second diaphragms are advantageous in that when the first portion of the moving armature moves in one direction a main part of the first diaphragm moves in the same direction. It should be noted however, that the movements of the first portion of the moving armature and at least part of the first diaphragm occur on opposite sides of the centre point of the moving armature whereby the total angular momentum around the centre point becomes zero if the masses of the moving armature, the first diaphragm and the drivepin (and the position thereof) are chosen correctly. Similarly, it is advantageous that when the second portion of the moving armature moves in one direction a main part of the second diaphragm moves in the same direction. Again it should be noted that the movements of the second portion of the moving armature and at least part of the second diaphragm occur on opposite sides of the centre point of the moving armature whereby the total angular momentum around the centre point becomes zero if the masses of the moving armature, the second diaphragm and the drivepin (and the position thereof) are chosen correctly.

Each of the first and second diaphragms may be hinged along at least one side. The opposite sides of the respective first and second diaphragms may be allowed to move freely.

The receiver assembly of the second aspect of the present invention may further comprise one or more microphone units, said one or more microphone units comprising one or more MEMS microphones and/or one or more electret microphones.

In a third aspect the present invention relates to a hearing device comprising a receiver assembly according to the first and/or second aspects, said hearing device comprising a hearing aid being selected from the group consisting of: behind-the-ear, in-the-ear, in-the-canal and completely-in-the-canal.

### BRIEF DESCRIPTION OF THE DRAWINGS

The present invention will now be described in further details with reference to the accompanying figures, wherein

FIG. 1 shows a first embodiment of the receiver assembly of the present invention with the moving armature in a balanced position,

FIG. 2 shows the first embodiment of the receiver assembly of the present invention with the moving armature in a displaced position,

FIG. 3 shows an enlarged portion of an embodiment of the present invention,

FIG. 4 shows a moving armature suspension arrangement where the moving armature is suspended in two armature bridges,

FIG. 5 shows a second embodiment of the receiver assembly of the present invention,

FIG. 6 shows a third embodiment of the receiver assembly of the present invention, and

FIG. 7 shows a fourth embodiment of the present invention.

While the invention is susceptible to various modifications and alternative forms specific embodiments have been shown by way of examples in the drawings and will be described in details herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its most general aspect the present invention relates to a hearing device receiver comprising a moving armature and at least one diaphragm being mechanically connected to the moving armature via a substantial rigid and stiff drivepin. The moving armature, the diaphragm and the drivepin are arranged in a manner so that the total angular momentum around a centre point of the receiver assembly is essentially zero.

In a preferred embodiment the hearing device receiver comprises a moving armature and two diaphragms connected thereto. The moving armature, the two diaphragms and two drivepins connecting the moving armature to the respective diaphragms are arranged in a manner so that the total angular momentum around a centre point of the receiver is essentially zero.

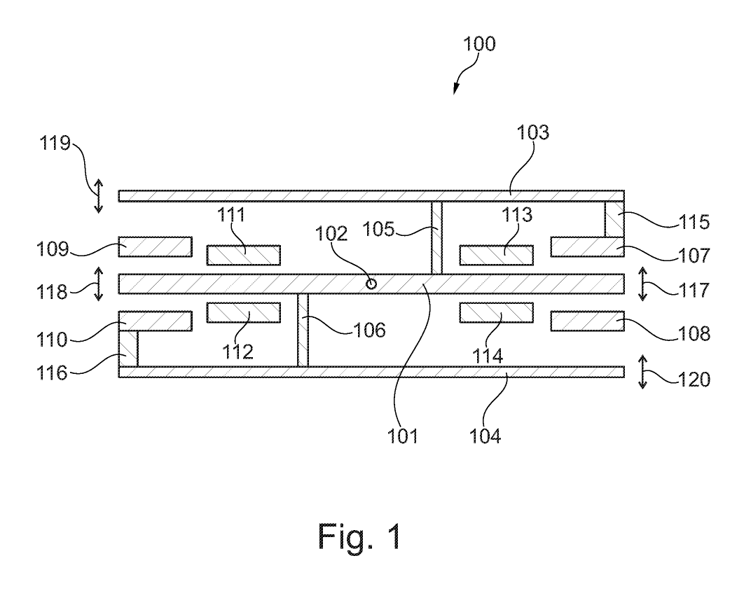

Referring now to FIG. 1 a cross-sectional view of an embodiment 100 of the present invention is depicted. The implementation of the receiver of the present invention is advantageous in that a single moving armature 101 drives two diaphragms 103, 104. This provides a mechanical as well as an acoustical coupling between the two halves of the receiver.

As seen in FIG. 1 the embodiment comprises a moving armature 101 which is configured to pivot or twist around a centre point 102. Thus, the moving armature ends are adapted to be moved up and down as indicated by the arrows 117, 118 when the moving armature pivots or twists around the centre point 102. The moving armature 101 is a substantially stiff member being made of a magnetic material.

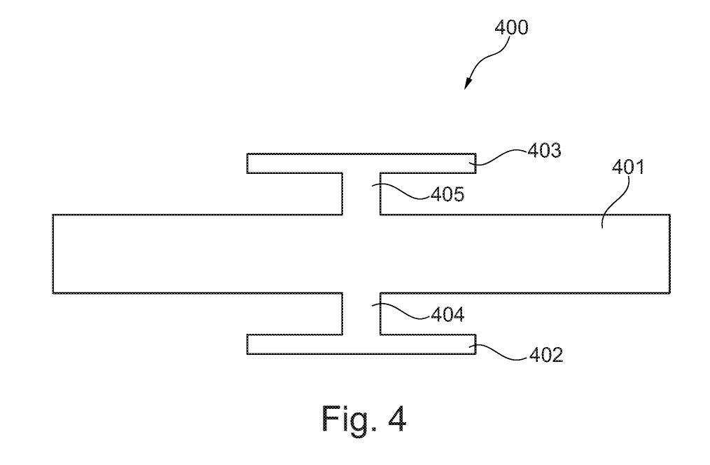

Various implementations may be applied for providing a pivoting or twisting mechanism of the moving armature 101 around the centre point 102. Thus, the moving armature 101 may for example pivot around an axle entering an opening or through-going hole in the moving armature 101. Alternatively, the moving armature 101 may be suspended in a flexible arrangement in which flexible arrangement the moving armature 101 is allowed to twist in response to an incoming drive signal. The flexible arrangement may for example include an armature bridge in the form of a torsion hinge, cf. FIG. 4.

The moving armature 101 is operatively connected to two diaphragms 103, 104 via respective drivepins 105, 106. The drivepins 105, 106 form substantially rigid connections between the moving armature 101 and the respective diaphragm 103, 104 so that movements of the moving armature 101 are transferred to the diaphragms 103, 104 as illustrated by arrows 119, 120, respectively. One end of the respective diaphragms 103, 104 are secured to the receiver via spacers 115, 116, respectively. The opposite ends of the diaphragms are allowed to vibrate freely as indicated by the arrows 119, 120. The two diaphragms 103, 104 are arranged in a substantial parallel manner.

Two pairs of permanent magnets 107, 108 and 109, 110 define respective air gaps at or near the opposite ends of the moving armature 101. In these air gaps permanent magnetic fields are generated. As seen in FIG. 1 at least a portion of the moving armature 101 is positioned in the before-mentioned air gaps.

Two static drive coils 113, 114 and 111, 112 are provided so that the moving armature 101 may pivot or twist in response to electrical drive signals being provided thereto.

As seen in FIG. 1 the diaphragm 103 is secured to the drivepin 105 in its right half within which right half it is also secured to the spacer 115. Also, the drivepin 105 is secured to the right half of the moving armature 101, i.e. being secured to a point of the moving armature 101 which point is to the right of the centre point 102. Similarly, the diaphragm 104 is secured to the drivepin 106 in its left half within which left half it is also secured to the spacer 116. Also, the drivepin 106 is secured to the left half of the moving armature 101, i.e. being secured to a point on the moving armature 101 which point is to the left of the centre point 102.

The embodiment of FIG. 1 may be operating with only a single drive coil 113, 114 and only two permanent magnets 107, 108. Thus, the drive coil 111, 112 and the permanent magnets 109, 110 may optionally be omitted.

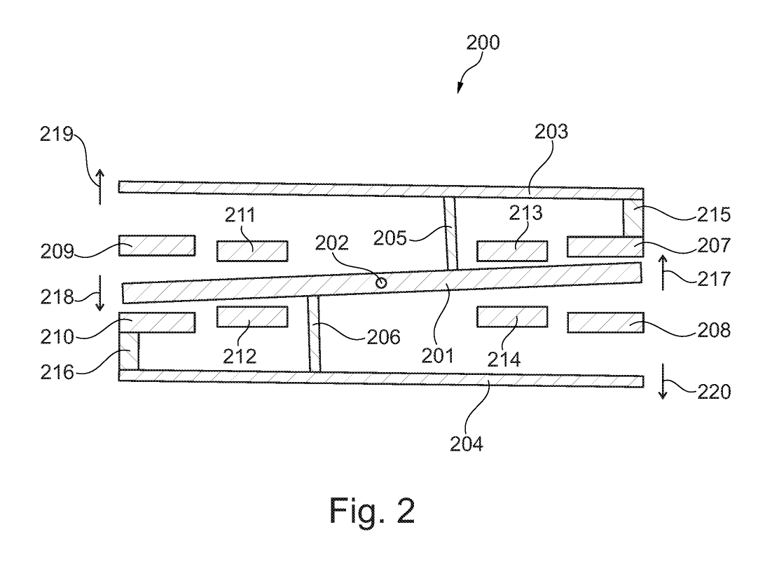

Referring now to FIG. 2 the moving armature 201 of the hearing device receiver 200 has been slightly pivoted or twisted around the centre point 202 as indicated by arrows 217, 218. The pivoting or twisting of the moving armature 201 is a result of a drive signal being applied to the two drive coils 211, 212 and 213, 214. As depicted in FIG. 2 the drivepin 205 pushes the diaphragm 203 up (cf. arrow 219), whereas the drivepin 206 pushes the diaphragm 204 down (cf. arrow 220). Similar to FIG. 1 the respective diaphragm 203, 204 are secured to spacers 215, 216, respectively. The four permanent magnets 207, 208 and 209, 210 define respective air gaps into which air gaps at least a portion of the moving armature 201 is extending.

As seen in FIG. 2 the upward directed movement 217 of the moving armature 201 causes the diaphragm 203 to move up as well, cf. arrow 219. Similarly, the downward directed movement 218 of the moving armature 201 causes the diaphragm 204 to move down as well, cf. arrow 220. Each of the various movements indicated by arrows 217-220 induces angular momentum around the centre point 202. However, in the receiver of the present invention the angular momentum induced by the armature movement 217 plus the angular momentum induced by the right half of the diaphragm 203 is essentially counteracted by the angular momentum induced by diaphragm movement 219, i.e. the movement of the left half of the diaphragm 203. Similarly, the angular momentum induced by the armature movement 218 plus the angular momentum induced by the left half of the diaphragm 204 is essentially counteracted by the angular momentum induced by diaphragm movement 220, i.e. the movement of the right half of the diaphragm 204. Thus, according to the present invention a hearing device receiver is provided wherein the moving armature 201, the two diaphragms 203, 204 and the two drivepins 205, 206 are arranged in a manner so that the total angular momentum around the centre point 202 is essentially zero.

Another approach to ensure that the total angular momentum around the centre point 202 is essentially zero is to ensure that the total angular momentum induced by the sum of the armature movement 217 and the diaphragm movement 219 is opposite and essentially equal in size compared to the total angular momentum induced by the sum of the armature movement 218 and the diaphragm movement 220.

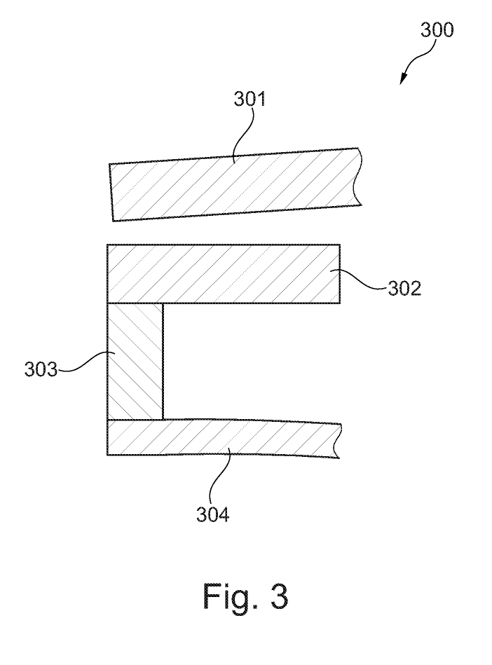

FIG. 3 shows an enlarged portion 300 of the lower left section of FIG. 2. As seen the moving armature 301 is in a pivoted or twisted position whereby the diaphragm 304 is slightly bended near its attachment to the spacer 303. One of the permanent magnets 302 is shown as well.

Referring now to FIG. 4 a moving armature suspension arrangement 400 is depicted. As seen in FIG. 4 the moving armature 401 is suspended in a pair of armature bridges 404, 405. Each of the two armature bridges 404, 405 form a torsion hinge in which torsion hinge the moving armature 401 is allowed to pivot or twist. Two fastening members 402, 403 are provided so that the moving armature suspension arrangement 400 can be fastened to a receiver housing (not shown). The moving armature 401, the armature bridges 404, 405 and the fastening members 402, 403 are preferably implemented as a one-piece component. Moreover, to ease production of the moving armature 401, the armature bridges 404, 405 and the fastening members 402, 403 the thickness of these are essentially the same.

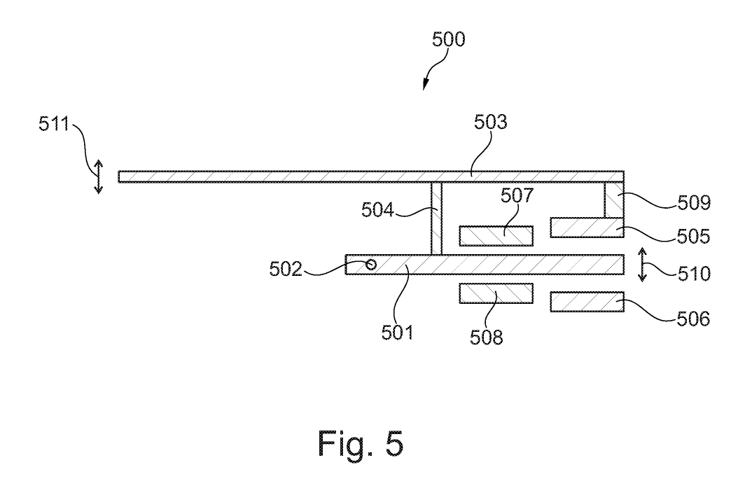

FIG. 5 shows another embodiment of the receiver assembly 500 of the present invention. Compared to the embodiment shown in FIG. 1 the embodiment depicted in FIG. 5 comprises only a single diaphragm 503 being operatively connected to a moving armature 501 via a substantially rigid drivepin 504. The moving armature 501 is allowed to pivot or twist around the centre point 502. A pair of torsion hinges, cf. FIG. 4, may be applied to suspend the moving armature 501. As seen in FIG. 5 a single drive coil 507, 508 and a single magnetic air gap are provided. The single magnetic air gap is provided between permanent magnets 505, 506. The diaphragm 503 is secured or fixated to spacer 509. As indicated by arrows 510, 511 the moving armature 501 and the free end of the diaphragm 503 are allowed to move in response to a drive signal being provided to the drive coil 507, 508. The moving armature 501 is operatively connected to the diaphragm 503 in a manner so that an angular momentum induced by movements of the moving armature 501 plus the angular momentum induced by the right half of the diaphragm 503 is essentially counteracted by an angular momentum induced by movements of the left half of the diaphragm 503. Thus, the total angular momentum around the centre point 502 is essentially zero.

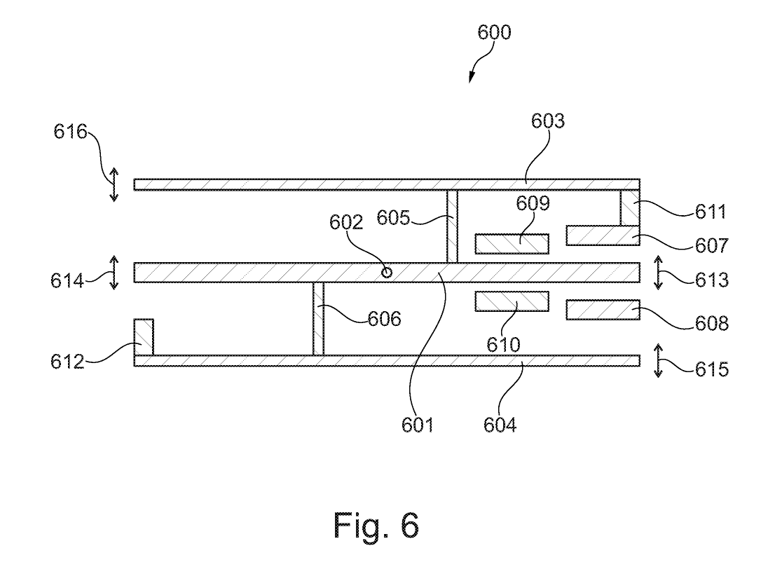

FIG. 6 shows yet another embodiment of the receiver assembly 600 of the present invention. Compared to the embodiments shown in FIG. 1 the embodiment depicted in FIG. 6 comprises only a single drive coil 609, 610 and a single magnetic air gap. The single magnetic air gap is provided between permanent magnets 607, 608. In FIG. 6 two diaphragms 603, 604 are operatively connected to a single moving armature 601 which is allowed to pivot or twist around the centre point 602. A pair of torsion hinges, cf. FIG. 4, may be applied to suspend the moving armature 601.The two diaphragms 603, 604, which are secured or fixated to spacers 611, 612, respectively, are operatively connected to the moving armature 601 via respective drivepins 605, 606.

As indicated by arrows 613-616 the moving armature 601 and the free ends of the diaphragms 603, 604 are allowed to move in response to a drive signal being provided to the drive coil 609, 610.

In FIG. 6 the right-hand side of the moving armature 601, i.e. the portion to the right of the centre point 602, is denoted the first portion of the moving armature 601. Similarly, the left- hand side of the moving armature 601, i.e. the portion to the left of the centre point 602, is denoted the second portion of the moving armature 601.

Similar to the embodiment shown in FIG. 1 the first portion of the moving armature 601 is operatively connected to the diaphragm 603 (via drivepin 605) in a manner so that an angular momentum induced by movements of the first portion of the moving armature 601 plus the angular momentum induced by the right half of the diaphragm 603 is essentially counteracted by an angular momentum induced by movements of the left half of the diaphragm 603. Similarly, the second portion of the moving armature 601 is operatively connected to the diaphragm 604 (via drivepin 606) in a manner so that an angular momentum induced by movements of the second portion of the moving armature 601 plus the angular momentum induced by the left half of the diaphragm 604 is essentially counteracted by an angular momentum induced by movements of the right half of the diaphragm 604.

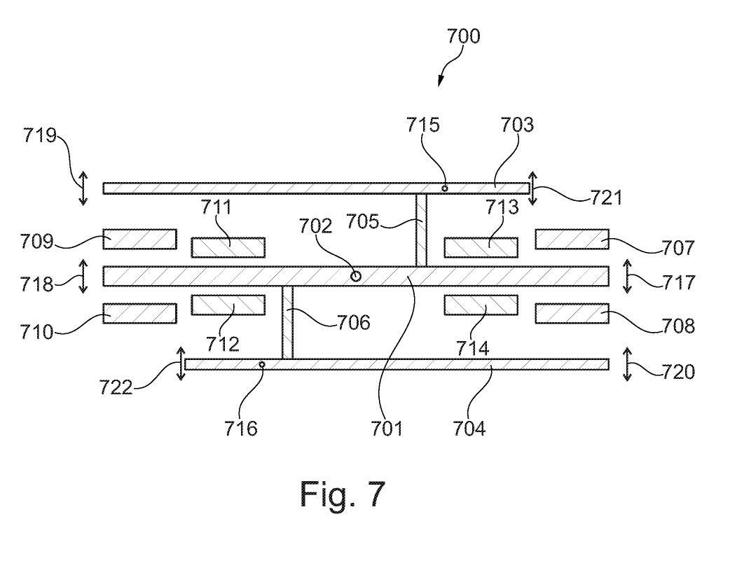

FIG. 7 shows yet another embodiment of the receiver assembly 700 of the present invention. Compared to the embodiments shown in FIG. 1 the embodiment depicted in FIG. 7 comprises pivotally hinged diaphragms 703, 704 being adapted to pivot or twist around respective pivot points 715, 716. In FIG. 7 the two diaphragms 703, 704 are operatively connected to a single moving armature 701 which is allowed to pivot or twist around the centre point 702. A pair of torsion hinges, cf. FIG. 4, may be applied to suspend the moving armature 701. The two diaphragms 703, 704 are operatively connected to the moving armature 701 via respective drivepins 705, 706. Similar to the embodiment of FIG. 1 a pair of drive coils 711-714 and four permanent magnets 707-710 are provided as well.

As indicated by arrows 717-722 the moving armature 701 and the diaphragms 703, 704 are allowed to pivot or twist in response to a drive signal being provided to the drive coils 711-714.

In FIG. 7 the right-hand side of the moving armature 701, i.e. the portion to the right of the centre point 702, is denoted the first portion of the moving armature 701. Similarly, the left- hand side of the moving armature 701, i.e. the portion to the left of the centre point 702, is denoted the second portion of the moving armature 701. The first portion of the moving armature 701 is operatively connected to the diaphragm 703 (via drivepin 705) in a manner so that an angular momentum induced by movements of the first portion of the moving armature 701 is essentially counteracted by an angular momentum induced by movements of the left side of the diaphragm 703. Similarly, the second portion of the moving armature 701 is operatively connected to the diaphragm 704 (via drivepin 706) in a manner so that an angular momentum induced by movements of the second portion of the moving armature 701 is essentially counteracted by an angular momentum induced by movements of the left side of the diaphragm 704.

Thus, the various embodiments of the receiver assembly of the present invention all facilitate that the total angular momentum around a centre point of the receiver assembly is essentially zero. In addition to the specific embodiments depicted above the following changes of the embodiments may be performed without departing from the scope of the present invention.

In the embodiments shown above drive coils have been depicted as static drive coils. However, the drive coils may be arranged to move with, i.e. follow, the moving armature. Thus, the drive coils may be attached to the moving armature. This would add weight to the moving system whereby a lower resonance frequency can be obtained.

The drivepins shown above are all positioned between the centre point and the drive coils. Alternatively, the drivepins can be positioned between the drive coils and the permanent magnets. Also, the drive coils may be split in two parts with drivepins then being positioned between such two drive coil parts.

Generally, the torsion hinge of FIG. 4 has three functions, namely: 1) prevent linear movements of the moving armature, 2) allowing rotational movements of the moving armature, and 3) providing a desired rotational stiffness. Function 3) can however also be provided by alternative means, such as resilient members (springs) suspending the moving armature.

Finally, magnetic return paths for the permanent magnets are needed. One option involves that the magnetic flux passes through the whole moving armature and the housing between the permanent magnets. Another option involves that the magnetic flux passes through only half of the moving armature and part of the housing between the permanent magnets. In the latter scenario the magnetic flux will enter/leave the moving armature through the torsion hinges.

1. A receiver assembly comprising:
a moving armature having a first portion, and
a first diaphragm being operatively connected to the first portion of the moving armature,
wherein the first portion of the moving armature is operatively connected to the first diaphragm in a manner so that an angular momentum induced by movements of the first portion of the moving armature is essentially counteracted by an angular momentum induced by movements of at least part of the first diaphragm.

2. A receiver assembly according to claim 1, wherein the moving armature is adapted to pivot or twist around a centre point separating the first portion and a second portion of the moving armature.

3. A receiver assembly according to claim 2, further comprising a first magnetic air gap and a first drive coil being adapted to interact with the first portion of the moving armature.

4. A receiver assembly according to claim 3, further comprising a second diaphragm being operatively connected to the second portion of the moving armature, wherein the second portion of the moving armature is operatively connected to the second diaphragm in a manner so that an angular momentum induced by movements of the second portion of the moving armature is essentially counteracted by an oppositely directed angular momentum induced by movements of at least part of the second diaphragm.

5. A receiver assembly according to claim 4, further comprising a second magnetic air gap and a second drive coil being adapted to interact with the second portion of the moving armature.

6. A receiver assembly according to claim 5, wherein the first and second magnetic air gaps are defined by respective pairs of permanent magnets.

7. A receiver assembly according to claim 6, wherein the respective pairs of permanent magnets are arranged at opposite ends of the moving armature.

8. A receiver assembly according to claim 7, wherein the respective pairs of permanent magnets are magnetised in essentially the same direction.

9. A receiver assembly according to claim 5, wherein the first drive coil is adapted to interact with at least part of the first portion of the armature between the centre point and the first magnetic air gap, and wherein the second drive coil is configured to interact with at least part of the second portion of the armature between the centre point and the second magnetic air gap.

10. A receiver assembly according to claim 9, wherein the first portion of the moving armature is operatively connected to the first diaphragm at a position between the first drive coil and the centre point, and wherein the second portion of the moving armature is operatively connected to the second diaphragm at a position between the second drive coil and the centre point.

11. A receiver assembly according to claim 4, wherein the first and second diaphragms are operatively connected to the respective first and second portions of the moving armature via substantially rigid connections.

12. A receiver assembly according to claim 4, wherein each of the first and second diaphragms is hinged along at least one side.

13. A receiver assembly according to claim 1, further comprising one or more microphone units, said one or more microphone units comprising one or more microelectromechanical (MEMS) microphones and/or one or more electret microphones.

14. A hearing device comprising a receiver assembly according to claim 1, said hearing device comprising a behind-the-ear hearing aid, an in-the-ear hearing aid, an in-the-canal hearing aid or a completely-in-the-canal hearing aid.

15. A receiver assembly comprising:
a moving armature having a first portion and a second portion,
a first diaphragm being operatively connected to the first portion of the moving armature, and
a second diaphragm being operatively connected to the second portion of the moving armature,
wherein angular momentums induced by combined movements of the first portion of the moving armature and the first diaphragm is essentially counteracted by angular momentums induced by combined movements of the second portion of the moving armature and the second diaphragm.

16. A receiver assembly according to claim 15, wherein the moving armature is adapted to pivot or twist around a centre point separating the first portion and the second portion of the moving armature.

17. A receiver assembly according to claim 16, further comprising a first magnetic air gap and a first drive coil being adapted to interact with the first portion of the moving armature, and a second magnetic air gap and a second drive coil being adapted to interact with the second portion of the moving armature.

18. A receiver assembly according to claim 17, wherein the first and second magnetic air gaps are defined by respective pairs of permanent magnets arranged at opposite ends of the moving armature, and wherein the respective pairs of permanent magnets are magnetised in essentially the same direction.

19. A receiver assembly according to claim 17, wherein the first drive coil is adapted to interact with at least part of the first portion of the armature between the centre point and the first magnetic air gap, and wherein the second drive coil is adapted to interact with at least part of the second portion of the armature between the centre point and the second magnetic air gap.

20. A receiver assembly according to claim 19, wherein the first portion of the moving armature is operatively connected to the first diaphragm at a position between the first drive coil and the centre point, and wherein the second portion of the moving armature is operatively connected to the second diaphragm at a position between the second drive coil and the centre point.

21. A receiver assembly according to claim 15, wherein the first and second diaphragms are operatively connected to the respective first and second portions of the moving armature via substantially rigid connections, and wherein each of the first and second diaphragms is hinged along at least one side.

22. A receiver assembly according to claim 15, further comprising one or more microphone units, said one or more microphone units comprising one or more microelectromechanical (MEMS) microphones and/or one or more electret microphones.

23. A hearing device comprising a receiver assembly according to claim 15, said hearing device comprising a behind-the-ear hearing aid, an in-the-ear hearing aid, an in-the-canal hearing aid or a completely-in-the-canal hearing aid.
